(19) United States
(12) Patent Application Publication
(10) Pub. No.: US 2002/0151282 A1
(43) Pub. Date: Oct. 17, 2002

(54) Joystick for cellular phone

(76) Inventor: Hvo-Sheng Wang, Pan Chiao City (TW)

Correspondence Address: BACON & THOMAS, PLLC, 625 SLATERS LANE, FOURTH FLOOR, ALEXANDRIA, VA, 22314

(21) Appl. No.: 09/882,181

(22) Filed: Jun. 18, 2001

(30) Foreign Application Priority Data
Apr. 13, 2001 (TW) 090205850

(51) Int. Cl. H04B 1/38

(52) U.S. Cl. 455/90; 455/550

(57) ABSTRACT

A joystick device for cellular phone comprises an upper fastening member on the keypad being clung onto the cellular phone and including a first central aperture and a plurality of openings around the aperture; an abutment member between the upper fastening member and the keypad and including a second central aperture, a plurality of projections around the central aperture thereof each being received in the opening but leaving a gap therebetween for providing an operating allowance, and a plurality of bottom studs each corresponding to one of the projections; and a joystick passed through the first central aperture and firmly fixed to the second central aperture of abutment member; whereby the joystick is operative to move to one of up, down, left, and right directions for causing one stud to contact a direction key on the cellular phone while playing due to the allowance. This can increase operation speed. Further, manipulation is convenient without been adversely affected by the small size of direction keys.

### FIELD OF THE INVENTION

The present invention relates to cellular phones and more particularly to a joystick for cellular phone having additional characteristics of ease manipulation.

### BACKGROUND OF THE INVENTION

Cellular phones have been popular worldwide in recent years due to portability thereof as a communication device. Further, a cellular phone may incorporate a variety of software packages such as game, phone book, voice box, alarm, message transmission, etc. With these software packages provided by the manufacturer, the purpose of providing a multifunctional cellular phone to the consumers may be achieved. Currently, user needs to press keys (e.g., direction keys) on cellular phone to play game. However, the size of direction key is relatively small. Hence, it is difficult for user to precisely press a desired direction key while playing game on cellular phone. This may frustrate users.

### SUMMARY OF THE INVENTION

It is an object of the present invention to provide a joystick device for cellular phone having a keypad consisting of a plurality of direction keys. The joystick device comprises an upper fastening member on the keypad of the cellular phone being clung onto the cellular phone and including a first central aperture, a plurality of openings around the aperture, and two ridged members on both outer sides; an abutment member between the upper fastening member and the keypad and including a second central aperture, a plurality of projections around the central aperture thereof each being received in the opening but leaving a gap therebetween for providing an operating allowance, and a plurality of bottom studs each corresponding to one of the projections; a joystick having a lower portion passed through the first central aperture of upper fastening member and fixed to the second central aperture of abutment member and a top handle; and a mating lower fastening member including two latches on both inner sides inserted into the ridged members for securing the upper and the lower fastening members and cellular phone together and a top pad frictionally contacting the bottom of the cellular phone; whereby the joystick is operative to move to one of up, down, left, and right directions for causing one stud to contact a direction key while playing due to the allowance provided by the gaps between projections and openings.

It is another object of the present invention to provide a joystick device for cellular phone further comprising a frame having a fitted magnifying glass extended from one side of the upper fastening member to cover a display of the cellular phone for increasing an apparent size thereof.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of joystick device according to the invention mounted on a cellular phone;

FIG. 2 is an exploded view of the FIG. 1 joystick device;

FIG. 3 is a sectional view of FIG. 1; and

FIG. 4 is a perspective view of a second preferred embodiment of joystick device according to the invention.

### DETAILED DESCRIPTION OF THE PREFERRED EMBODIMENTS

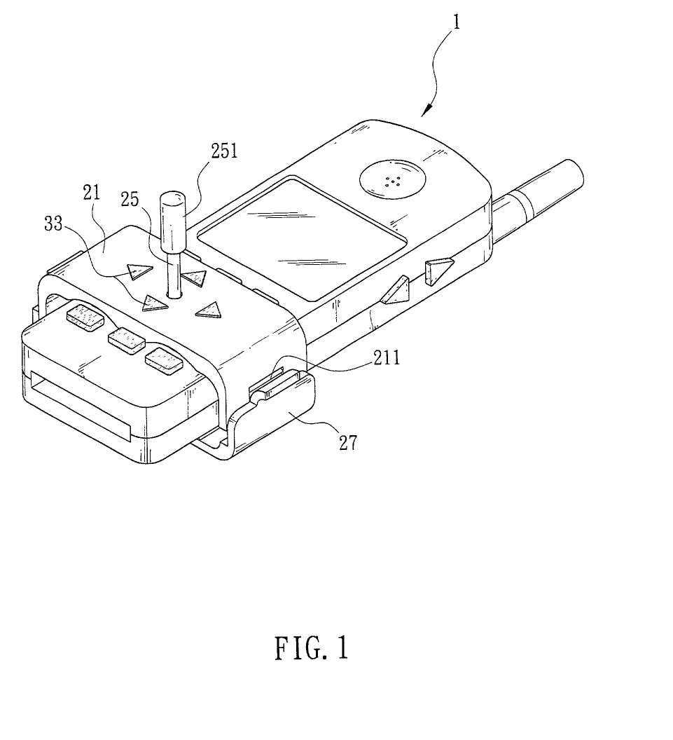

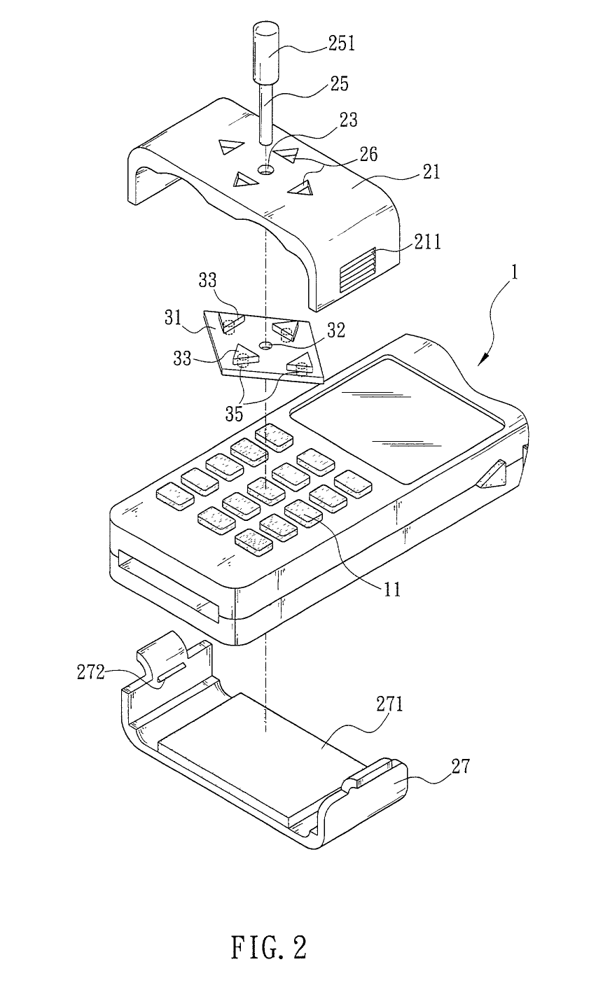

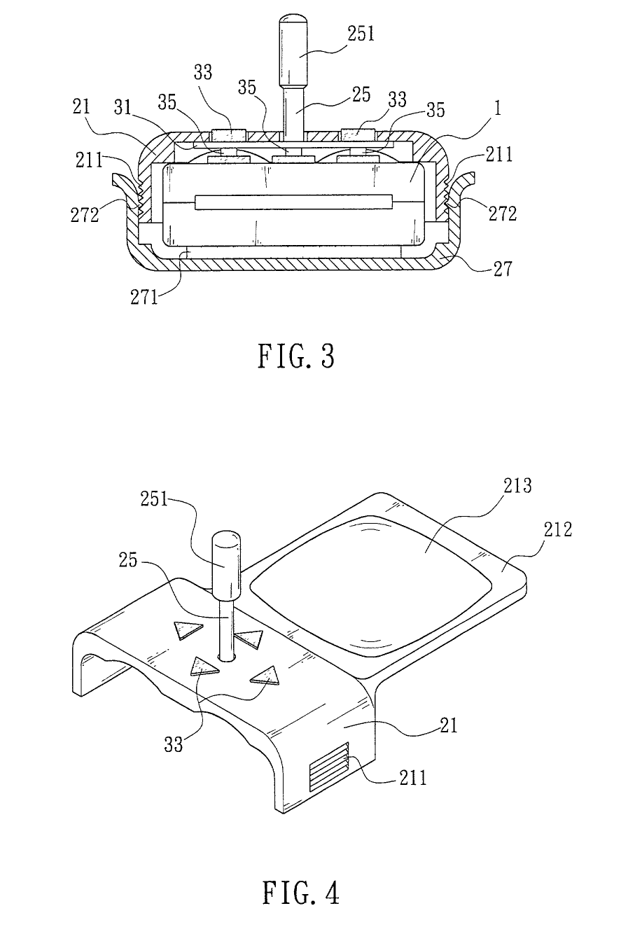

Referring to FIGS. 1 to 3, there is shown a joystick device constructed in accordance with a first embodiment of the invention mounted on a cellular phone 1. Joystick comprises an upper fastening member 21 disposed corresponding to keypad 11 of cellular phone 1 and including a first central aperture 23, a plurality of triangular openings 26 around first central aperture 23, and two ridged members 211 on both outer sides; an abutment member 31 between upper fastening member 21 and keypad 11 and including a second central aperture 32, a plurality of triangular projections 33 around the second central aperture 32 each being received in opening 26 but having a gap therebetween, and a plurality of bottom studs 35 each corresponding to a projection 33; a joystick 25 with lower portion passed through the first central aperture 23 and firmly fixed to the second central aperture 32 of abutment member 31 and having a handle 251 on the top; and a mating lower fastening member 27 including a pad 271 on the top frictionally contacting the bottom of cellular phone 1 and two latches 272 on both inner sides inserted into ridged members 211 for securing upper and lower fastening members 21 and 27 and cellular phone 1 together. With this construction, user may smoothly manipulate joystick 25 to move to one of up, down, left, and right directions for causing one stud 35 to contact a direction key on cellular phone 1 while playing due to the allowance provided by the gaps between projections 33 and openings 26.

Referring to FIG. 4, there is shown a second embodiment of joystick device. The difference between first and second embodiments is that a frame 212 having a fitted magnifying glass (e.g., convex lens) 213 is extended from one side of upper fastening member 21 to cover the display of cellular phone 1 for increasing apparent size of the display. Hence, user may see clearly the characters or icons shown on the display while playing.

The advantages of the invention are as follows: The speed is increased while manipulating joystick 25 to cause studs 35 to contact direction key of cellular phone 1. Manipulation is easy and convenient without been adversely affected by the small size of direction keys.

While the invention has been described by means of specific embodiments, numerous modifications and variations could be made thereto by those skilled in the art without departing from the scope and spirit of the invention set forth in the claims.

What is claimed is:

1. A joystick device for cellular phone having a keypad consisting of a plurality of direction keys, joystick device comprising:
an upper fastening member of the size being clung onto a cellular phone and including a first central aperture and a plurality of openings around said aperture;
an abutment member between said upper fastening member and said keypad and including a second central aperture, a plurality of projections around said central aperture thereof each being received in said opening but leaving a gap therebetween for providing an operating allowance, and a plurality of bottom studs each corresponding to one of said projections; and
a joystick having a lower portion passed through said first central aperture and firmly fixed to said second central aperture of abutment member;
whereby said joystick is operative to move to one of up, down, left, and right directions for causing one of said studs to contact a direction key on keypad of said cellular phone while playing due to said allowance.

2. The joystick device of claim 1, wherein said upper fastening member further comprises two ridged members on both outer sides, further comprising a mating lower fastening member including two latches on both inner sides inserted into said ridged members for securing said upper and said lower fastening members and cellular phone together.

3. The joystick device of claim 2, wherein said lower fastening member further comprises a top pad frictionally contacting said bottom of said cellular phone.

4. The joystick device of claim 1, wherein said joystick further comprises a top handle.

5. The joystick device of claim 1, further comprising a frame having a fitted magnifying glass extended from one side of said upper fastening member to cover a display of said cellular phone for increasing an apparent size thereof.
